(19) United States
(12) Patent Application Publication
(10) Pub. No.: US 2009/0154002 A1
(43) Pub. Date: Jun. 18, 2009

(54) METHODS AND APPARATUS TO CONTROL HEAD EXPANSION IN MULTI-HEAD HARD-DISK DRIVES

(76) Inventors: Toru Takeuchi, Kanagawa (JP); Motomu Hashizume, Tokyo (JP); Hiroyuki Mukai, Kanagawa (JP)

Correspondence Address: TEXAS INSTRUMENTS INCORPORATED, P O BOX 655474, M/S 3999, DALLAS, TX, 75265, US

(21) Appl. No.: 12/146,934

(22) Filed: Jun. 26, 2008

Related U.S. Application Data
(60) Provisional application No. 61/012,986, filed on Dec. 12, 2007.

(51) Int. Cl. G11B 21/02

(52) U.S. Cl. 360/75

(57) ABSTRACT

Methods and apparatus to control head expansion in multi-head hard-disk drives are disclosed. An example control system for use in a multi-head hard-disk drive includes a first sensor to provide a first feedback signal indicating a status of a first head; a second sensor to provide a second feedback signal indicating a status of a second head; and a shared calculation unit to selectively receive one of the first and second feedback signals for a feedback process to control an expansion of the first and second heads.

### RELATED APPLICATION

This application claims the benefit of U.S. Provisional Application No. 61/012,986, filed Dec. 12, 2007, the entirety of which is incorporated by reference.

### FIELD OF DISCLOSURE

This disclosure relates generally to hard-disk drives and, more particularly, to methods and apparatus to control head expansion in multi-head hard-disk drives.

### BACKGROUND

A hard-disk drive (HDD) is a non-volatile storage device that stores encoded data on one or more rotating platters having magnetic surfaces. To read and write data, the HDD includes read and write heads positioned near the magnetic surfaces. Briefly, a write operation includes applying a magnetic field to selected portions of a platter surface. A read operation includes sensing the polarity of the magnetic field stored at different portions of the platter surface.

Accordingly, the overall performance of read and write operations depends on the strength of the magnetic fields stored on the magnetic surfaces of the platters and, in turn, the ability of the read head to detect the magnetic fields. Because magnetic field strength decreases over distance, any reduction in the space between the read/write heads and the surfaces of the platters (referred to herein as the “fly height” of the read/write heads) improves reliability and consistency. However, a low fly height has the potential to cause dragging of the read/write heads along a platter surface (e.g., during a braking operation). Contact between the read/write heads and the surface causes particles (e.g., coating particles) to loosen, leading to defects and/or general failure.

Typically, a suspension system controls the fly height of the read/write heads. Further, recent developments have enabled designers to control a thermal expansion of the read/write heads using a resistive element disposed therein. In particular, dissipated heat causes the expansion, thereby reducing the distance between the read/write heads and the magnetic surfaces of the platters.

### SUMMARY OF THE INVENTION

To control a thermal expansion of read and/or write heads in a hard-disk drive (HDD), the example control systems described herein undergo a feedback process to regulate an amount of power delivered to resistive elements disposed within the read/write heads. The thermal expansion decreases the distance between read/write heads and the surface of an HDD platter. In the illustrated examples, various components are shared among a plurality of read/write heads, thereby reducing space requirements and performance discrepancies caused by component variation. In some examples, the control system selects one of the read/write heads for the feedback process according to a cyclical sequence. The amount of power delivered to an unselected read/write head is determined by a control signal stored on a capacitive element while the unselected head was undergoing the feedback process.

### BRIEF DESCRIPTION OF THE DRAWINGS

FIG. 1A is a block diagram of a known apparatus to control a thermal expansion of a head assembly.

FIG. 1B illustrates an example implementation of the heater controller of FIG. 1.

FIG. 2 is an illustration of an example hard-disk drive (HDD) including an example heater control system.

FIG. 3 is an illustration of an example implementation of the example heater control system of FIG. 2.

FIG. 4 is a group of plots showing a plurality of signals of the example heater control system of FIG. 3 vertically aligned to show relative timing.

FIG. 5 illustrates another example implementation of the example heater control system of FIG. 2.

FIG. 6 is a schematic illustration of an example processor platform that may be used and/or programmed to implement the methods and apparatus described herein.

### DETAILED DESCRIPTION

Although the fly height of read/write head assemblies can be controlled by a conventional suspension system, some current hard-disk drives (HDDs) employ additional or alternative techniques to further reduce fly height and to increase the precision with which fly height is controlled. One such technique employs a resistive element disposed within the read/write heads to control an expansion of the read/write heads in response to heat (e.g., as generated by current flowing through the resistive element). By controlling the temperature of the read/write heads, or at least a portion thereof (e.g., the portion nearest the magnetic surface of a platter), the fly height of a head assembly can be adjusted according to, for example, feedback signals indicating a status of the resistive element.

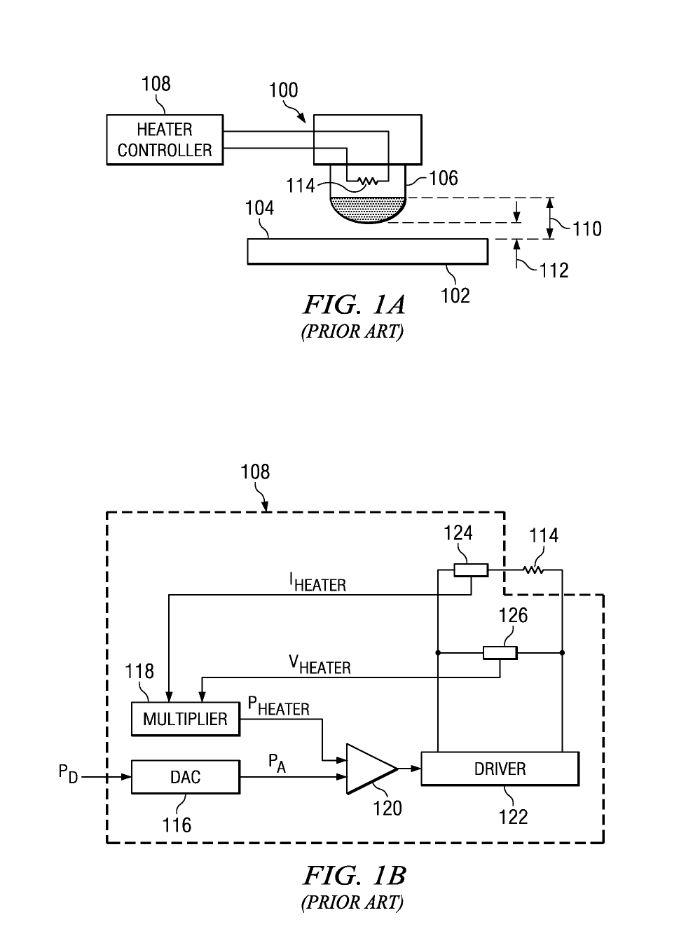

FIG. 1A is a block diagram of a known apparatus to control a thermal expansion of an example head assembly 100. The head assembly 100 is suspended over an HDD platter 102 having a magnetic surface 104 to interact with a read/write head 106. In addition to a suspension system (not shown) that controls fly height over the surface 104, the head assembly 100 is coupled to a heater controller 108 to control an expansion of the read/write head 106. The expansion is represented in FIG. 1A by the darkened portion extending toward the magnetic surface 104. As shown in FIG. 1A, the expansion of the read/write head 106 reduces the fly height of the head assembly 100 from a first distance, represented by reference numeral 110, to a second distance, represented by reference numeral 112. As described above, such a reduction in fly height enables the read/write head 106 to more accurately write and read to and from the platter 102 due to, in part, the increased strength of the magnetic field at shorter distances between the head assembly 100 and the platter 102.

Generally, current flowing through the read/write head 106 causes a natural thermal expansion. Accordingly, the amount of expansion that occurs depends on how much power is being dissipated in the read/write head 106 at any given moment. To provide greater control over the expansion, the read/write head 106 includes a resistive element, which is shown as a resistor 114 in FIG. 1A. The resistor 114 is coupled to the heater controller 108, which receives feedback signals from the resistor 114 and provides signals to the resistor 114. FIG. 1B illustrates a known implementation of the heater controller 108 of FIG. 1. The heater controller 108 includes a digital-to-analog converter (DAC) 116, a multiplier 118, an amplifier 120, a driver circuit 122, a current sensor 124, and a voltage sensor 126.

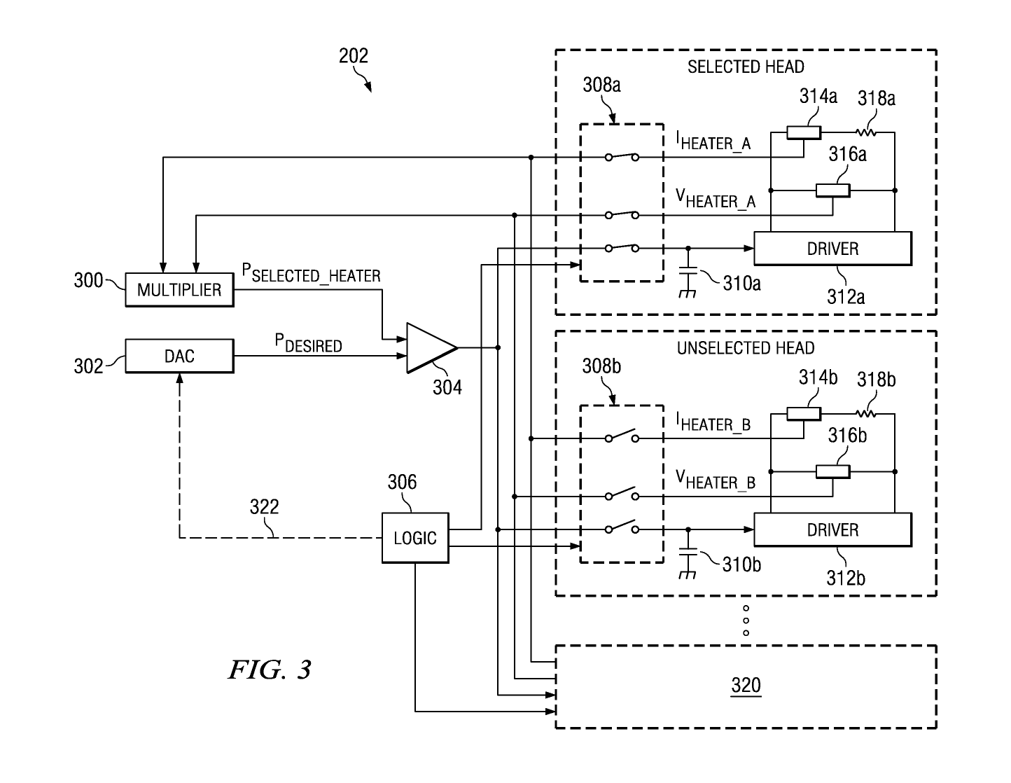

The DAC 116 receives a power input signal PD that originates in, for example, a preamplifier of a control system of the HDD, as described in greater detail below in connection with FIG. 3. The power signal P_{D} is a digital representation of the desired power to be delivered to the resistor 114. The DAC 116 converts the digital power signal P_{D} to an analog power signal P_{A}, which is conveyed to the amplifier 120. As described below, the desired power signal P_{A} is a predetermined value that is used by the driver circuit 122 to supply power to the resistor 114.

The amplifier 120 also receives a signal P_{HEATER} from the multiplier 118. The signal P_{HEATER} indicates the power being delivered to the resistor 114 at a given time. To measure the power being delivered to the resistor 114, the multiplier 118 receives two feedback signals I_{HEATER} and V_{HEATER} from the current sensor 124 and the voltage sensor 126, respectively. As is known, the power being delivered to an electronic component is measured by, for example, computing the product of the current flowing through the component and the voltage across the component. Thus, the two feedback signals I_{HEATER} and V_{HEATER} are conveyed to the multiplier 118, which in turn generates the power signal P_{HEATER} and conveys the same to the amplifier 120.

The amplifier 120 drives one or more components of the driver circuit 122. For example, the driver circuit of FIG. 1B includes a variable current source that is driven by the output of the amplifier 120. The variable current source may be implemented as one or more output drive transistors receiving the output of the amplifier 120 (e.g., a control voltage) at a control terminal (e.g., a gate). In such examples, the output of the amplifier 120 regulates the amount of current (e.g., as provided by a voltage source coupled to the drive transistors) delivered to the resistor 114. As is known, the amount of current delivered to the resistor 114 (e.g., which is measured and reflected by the feedback signal I_{HEATER}) determines how much heat is dissipated in the read/write head 106. In turn, the amount of current delivered to the resistor 114 (along material characteristics of the read/write head 106) determines the magnitude or degree of thermal expansion experienced by the read/write head 106.

Generally, the amplifier 120 adjusts the heat dissipation of the resistor 114 in response to any variations detected between the desired power signal P_{A} and the actual power P_{HEATER} being delivered to the resistor 114. In particular, if the actual power signal P_{HEATER} is less than the desired power signal P_{A}, the amplifier 120 generates a signal that causes an increase in current delivered to the resistor 114. A greater current flowing through the resistor 114 increases heat dissipation and, thus, the magnitude of thermal expansion of the read/write head 106. If the actual power signal P_{HEATER} is greater than the desired power signal P_{A}, the amplifier 120 generates a signal to decrease current delivered to the resistor 114. A lesser current flowing through the resistor 114 decreases heat dissipation and, thus, the magnitude of thermal expansion of the read/write head 106. Therefore, the feedback signals I_{HEATER} and V_{HEATER} and the amplifier 120 interact to maintain the desired power delivered to the resistor 114, thereby providing control over the fly height of the head assembly 100.

However, certain aspects of the conventional approach illustrated in FIGS. 1A and 1B lead to drawbacks and additional design challenges. Specifically, in multi-head HDDs that employ the thermal expansion techniques described above, a plurality of multipliers and a plurality of amplifiers are installed to monitor and control the resistive elements disposed in the individual read/write heads. The plurality of multipliers and the plurality of amplifiers require added space and result in higher costs. Moreover, the multipliers and amplifiers have varying characteristics due to manufacturing and material inconsistencies. As with any system, varying characteristics and inconsistent performance lead to unpredictable behavior. In this case, the additional multipliers and amplifiers lead to variations in the computations that control the thermal expansion of the read/write heads and, thus, the fly height of each read/write head. As described above, imprecise control over fly heights may result in contact between a read/write head and a magnetic surface of a platter, thereby causing performance degradation and/or defects from, for example, particles loosened as result of contact with the read/write heads. The methods and apparatus described herein address these and other problems associated with HDD control systems.

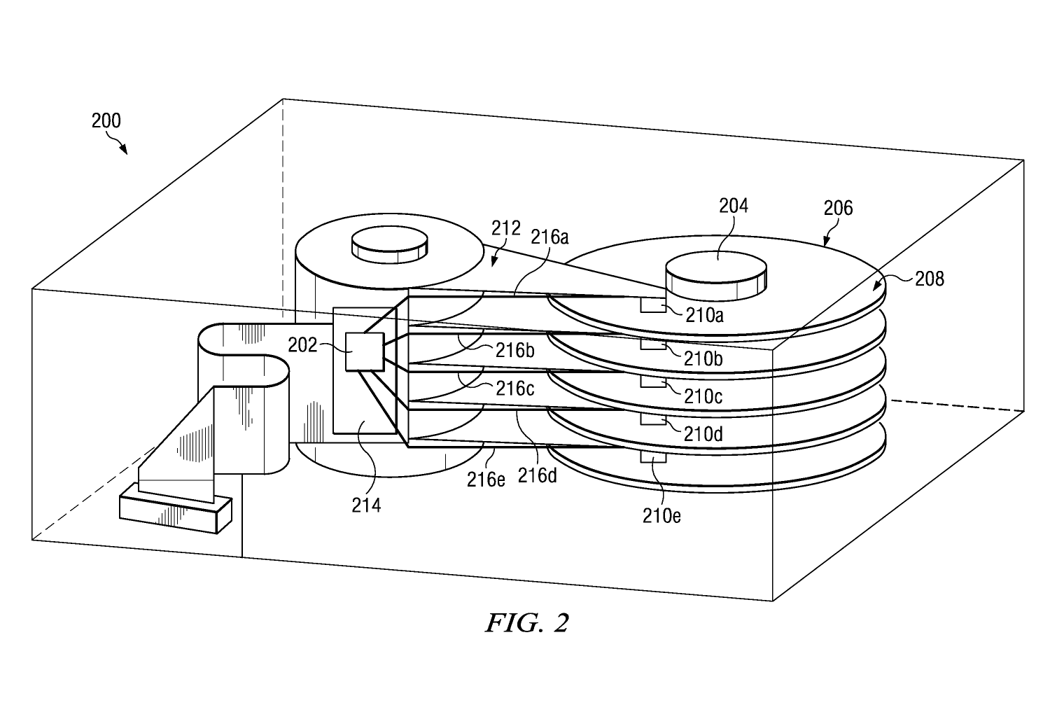

FIG. 2 is an illustration of an example HDD 200 including an example heater control system 202 to implement the example methods and apparatus described herein. The HDD 200 includes a spindle 204 that holds a plurality of platters 206 having magnetic surfaces (e.g., comprising magneto-resistive material) 208 that store readable data. To provide a plurality of read/write heads 210a-e access to the entire data-storing portions of the platter surfaces 208, a motor (e.g., a three-phase, direct current brushless spindle motor) (not shown) rotates the platters 206 by way of the spindle 204 at a substantially constant speed (e.g., 10,000 revolutions per minute (rpm), 7,200 rpm, or 5,400 rpm) during a read or write operation. Further, each of the read/write heads 210a-e are coupled to one of a plurality of actuator arms 212 that move radially across the platters 206, as controlled by a voice coil motor (not shown). The actuator arms 212 suspend the read/write heads 210a-e in close proximity over the platter surfaces 208 at a predetermined fly height. Each of the read/write heads 210a-e includes a resistive element (e.g., the resistors 310a and 310b described below in connection with FIG. 3) to provide additional control over the fly height of each of the head assemblies on which the read/write heads 210a-e are implemented. As described above, the resistive elements disposed within the read/write heads enable increased head heating and its attendant thermal expansion to decrease fly height, thereby increasing the strength of the magnetic fields between the read/write heads 210a-e and the platter surfaces 208.

In the illustrated example of FIG. 2, a controller 214 is implemented in the HDD 200 to operate the components described above. In other examples, the controller 214 may be implemented elsewhere, such as in another controller of the system in which the HDD 200 is implemented (e.g., a server, a personal computer, or any other processing unit). The example controller 214 of FIG. 2 includes a servo control unit (not shown) to drive the rotation of the spindle 204 and the operation of the actuator arms 212. Further, the example controller 214 of FIG. 2 sends signals to the read/write heads 210a-e to control read/write operations for obtaining and storing data from and within the HDD 200.

In the illustrated example of FIG. 2, the controller 214 also includes the heater control system 202. In other examples, such as when the controller 214 is implemented external to the HDD 200, the heater control system 202 may be implemented separately from the controller 214, as an independent unit within or outside the HDD 200. In some examples, the heater control system 202 is implemented in a preamplifier that drives the read/write heads 210a-e. The heater control system 202 receives a plurality of feedback signals 218a-e from the plurality of read/write heads 210a-e. As described in greater detail below in connection with FIG. 3, the example heater control system 202 of FIG. 2 employs methods and apparatus that control the thermal expansion process described above more efficiently, accurately, and effectively than previous approaches. In particular, by providing components that can be commonly utilizes by more than one read/write head, the heater control system 202 improves upon and/or eliminates several aspects and/or components of conventional control systems that lead to inconsistencies, high potential for defects, and overall degradation of performance.

FIG. 3 is an illustration of an example implementation of the example heater control system 202 of FIG. 2. Generally, the example heater control system 202 of FIG. 3 utilizes a configuration that enables a single multiplier 300, a single DAC 302, and a single amplifier 304 to monitor and control the thermal expansion of the plurality of read/write heads 210a-e of FIG. 2. Unlike previous systems (e.g., the heater controller 108 of FIG. 1) that include a multiplier, a DAC, and an amplifier dedicated to each read/write head, the example heater control system 202 of FIG. 3 is able to share a common multiplier 300, a common DAC 302, and a common amplifier 304 to control more than one of the read/write heads 210a-e. Accordingly, the example heater control system 202 of FIG. 3 reduces space requirements related to read/write control systems. Additionally, sharing one or more components, as illustrated in FIG. 3, eliminates variations introduced into the HDD 200 by having multiple multipliers, amplifiers, and/or DACs, all having inconsistencies (e.g., manufacturing discrepancies, varying degradations resulting from prolonged usage, etc.).

In addition to the multiplier 300, the DAC 302, and the amplifier 304, the example heater control system 202 of FIG. 3 includes a logic unit 306, first and second switch modules 308a and 308b, first and second capacitive elements 310a and 310b, first and second drivers 312a and 312b, first and second current sensors 314a and 314b, first and second voltage sensors 316a and 316b, and first and second resistive elements 318a and 318b. In other examples, the common amplifier 304 of FIG. 3 may be eliminated and a plurality of amplifiers may be individually dedicated to each read/write head 210a-e.

In the illustrated example, the first set of components (those labeled with reference numerals ending in ‘a’) corresponds to a first one of the plurality of read/write heads 210a-e, namely the first read/write head 210a. The second set of components (those labeled with reference numerals ending in ‘b’) corresponds to a second one of the plurality of read/write heads 210a-e, namely the second read/write head 210b. While FIG. 3 shows the portions of the heater control system 202 corresponding to the top two read/write heads 210a and 210b, the example heater control system 202 of FIG. 3 includes similar implementations of the components listed above for the remainder of the read/write heads 210c-e, as represented in FIG. 3 by the dashed box 320. In the illustrated example of FIG. 3, the common multiplier 300, the common DAC 302, and the common amplifier 304 are in communication with and operate each of the plurality of read/write heads 210a-e. In other example implementations, a common multiplier, a common DAC, and/or a common amplifier may be assigned to and operate a subset of a plurality of read/write heads. For example, an HDD having eight read/write heads may include a first set of common control components (e.g., a first shared multiplier, a first shared amplifier, and a first shared DAC) to manage a first four of the read/write heads and a second set of common control components (e.g., a second shared multiplier, a second shared amplifier, and a second shared DAC) to manage a second four of the read read/write heads. In other words, the example methods and apparatus described herein enable a greater than one-to-one ratio of shared control components to read/write heads.

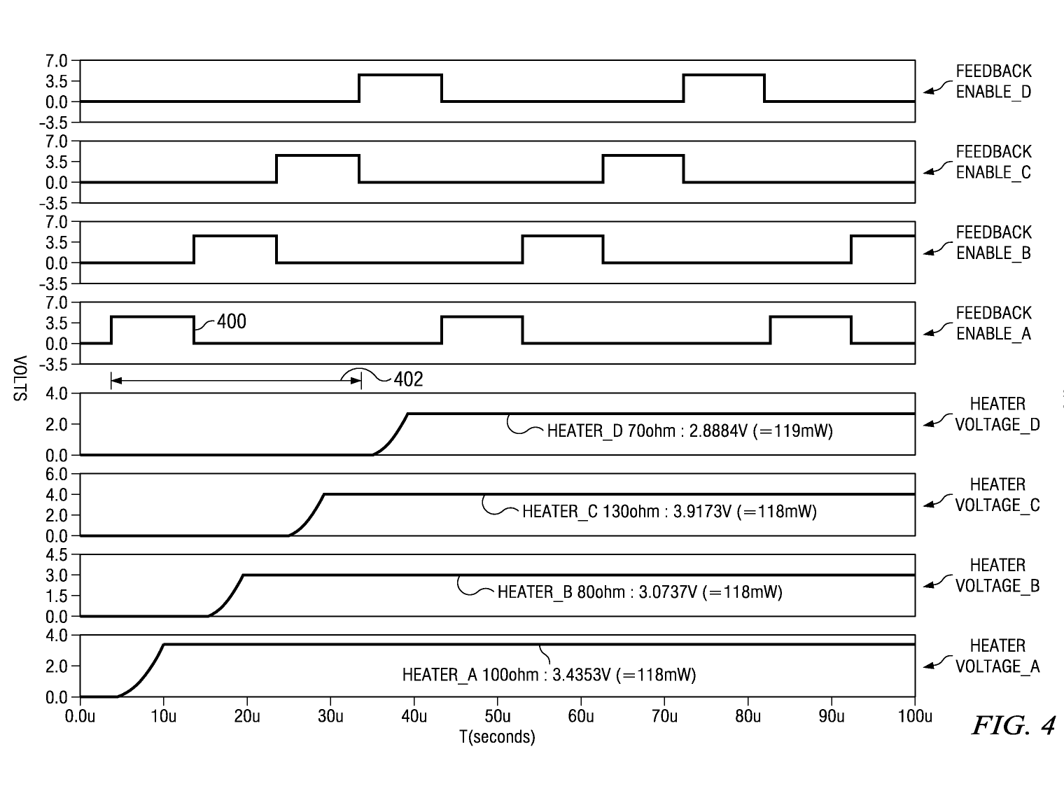

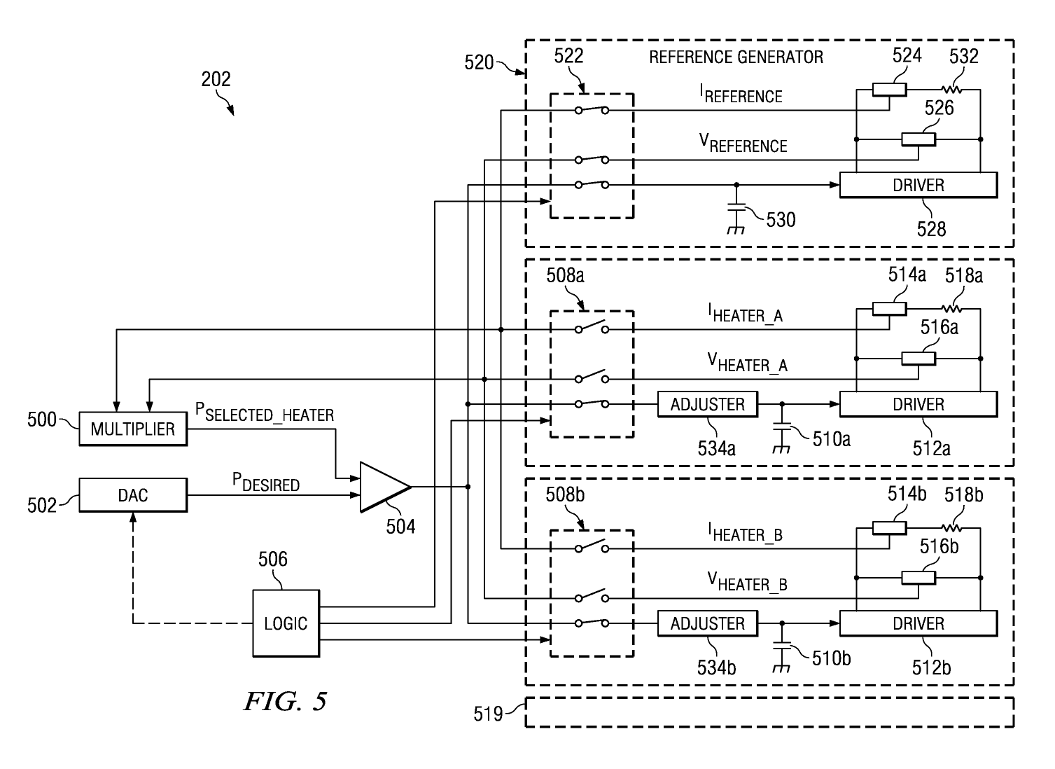

The resistive elements 318a and 318b, which are illustrated in the example of FIG. 3 as resistors, operate to cause and its associated thermal expansion of the read/write heads 210a-e, thereby reducing fly height. To control the thermal expansion (and to avoid any of the potential negative complications associated with reduced fly heights (e.g., dragging of the read/write heads 210a-e along the platter surfaces 208)), the current sensors 314a and 314b and the voltage sensors 316a and 316b convey feedback signals to the multiplier 300. Specifically, at certain times the multiplier 300 receives a first current signal I_{HEATER}_{_{—}}_{A} and a first voltage signal V_{HEATER}_{_{—}}_{A} from the first current sensor 314a and first voltage sensor 316a, respectively. At other times, the multiplier 300 receives a second current signal I_{HEATER}_{_{—}}_{B} and a first voltage signal V_{HEATER}_{_{—}}_{B} from the second current sensor 314b and second voltage sensor 318b, respectively. In other words, one of the plurality of read/write heads 210a-e is selected at any given time to provide feedback to the multiplier 300. In the illustrated example of FIG. 3, the first read/write head 210a is shown as selected for the feedback process described herein. Further, in the illustrated example of FIG. 3, the selection of a read/write head for the feedback process is made in a cyclical manner, which is described in greater detail below in connection with FIGS. 4 and 5.

In the illustrated example of FIG. 3, the multiplier 300 determines the product of the current flowing through (I_{HEATER}_{_{—}}_{A}) and the voltage across (V_{HEATER}_{_{—}}_{A}) the selected resistive element 318a. The multiplier 300 then conveys the results of the calculation (voltage*current=power) to the amplifier 304 as a signal P_{SELECTED}_{_{—}}_{HEATER} representing the actual power being delivered to the selected resistive element 318a. In some examples, additional or alternative parameters or characteristics can be used to calculate the actual power being delivered to one of the resistive elements (e.g., the first or second resistive element 318a or 318b). For example, where the resistance of the resistive element is known (e.g., via a measurement taken during a testing stage), power may be calculated in the multiplier 300 according to the equation I²*R or the equation V²/R. In such instances, other calculation modules (e.g., a divider) may be implemented in association with or in place of the multiplier 300.

The amplifier 304 also receives a signal P_{DESIRED} from the DAC 302 representing the desired power to be delivered to the resistive element 318a. In the illustrated example of FIG. 3, the desired power P_{DESIRED} is a predetermined value based on, for example, characteristics of the read/write heads (e.g., impedance, temperature coefficients, material properties, thermal expansion coefficients, etc.), that is delivered as a digital signal to the DAC 302, which converts the digital signal to an analog signal.

The amplifier 304 adjusts the power being delivered to the resistive element 318a, via the selected driver 312a, to resolve any difference between the actual power signal P_{SELECTED}_{_{—}}_{HEATER} and the desired power signal P_{DESIRED}. Specifically, the example drivers 312a and 312b of FIG. 3 include variable current sources, (e.g., drive transistors coupled voltage sources) that are driven by the output of the amplifier 304. In the example of FIG. 3, the output of the amplifier 304 comprises a voltage to drive a control terminal (e.g., a gate) of, for example, a transistor. Thus, the resistive element 318a receives current, the magnitude of which is controlled by the output of the amplifier 304, that causes the thermal expansion of the read/write heads described herein.

To implement the selection process, the switch modules 308a and 308b are in communication with the logic unit 306. The logic unit 306 is programmed to selectively couple the feedback components (a current sensor and a voltage sensor) associated with a selected read/write head to the multiplier 300. Further, the logic unit 306 is programmed to selectively couple the driver (e.g., the first driver 312a or the second driver 312b) associated with the selected read/write head to the amplifier 304. In other words, the logic unit 306 and the switch modules 308a and 308b operate to place one of the plurality of read/write heads 210a-e in communication with the multiplier 300 and the amplifier 304. During such a period of communication, the status of a resistive element of the selected read/write head (e.g., the resistor 318a of the first read/write head 210a) is determined and a response to that status is generated. As shown in FIG. 3, the switches of the first switch module 308a are closed to enable a period of communication between the first read/write head 210a and the multiplier 300 and amplifier 304. While in communication with the selected resistive element 318a, the heater control system 202 determines the magnitude of current to be delivered to the resistive element 318a based on the feedback signals I_{HEATER}_{_{—}}_{A} and V_{HEATER}_{_{—}}_{A}. The heater control system 202 then controls the output voltage of the first driver 312a accordingly.

In the illustrated example of FIG. 3, the desired power signal P_{DESIRED} is substantially the same for each of the plurality of read/write heads 210a-e. In other examples, such as HDDs having a relatively large number (e.g., ten or twelve) of read/write heads, the desired power signal P_{DESIRED} may be different for one or more of the read/write heads. For example, due to differences in size, material characteristics, resistance, or any other aspect that changes the suitable power to be delivered to a read/write head, a larger or small magnitude of power may be needed to thermally expand one or more of the read/write heads to a preferred degree. In such instances, the example logic unit 306 of FIG. 3 may be coupled to the DAC 302 (referring to the dashed line 322 of FIG. 3) to implement a synchronization of the selection process and the varying desired power signals associated with individual selected read/write heads. For example, when the logic unit 306 currently selects the first read/write head 210a for the feedback process described herein, the logic unit 306 may also provide instruction(s) to the DAC 302 regarding which magnitude of desired power corresponds with the first read/write head 210a and the resistive element 318a thereof. When the logic unit 306 selects the second read/write head 210b for the feedback process, the logic unit 306 may also provide instruction(s) to the DAC 302 regarding which magnitude of desired power corresponds with the second read/write head 210b and the resistive element 318b thereof, which may be different from the desired power corresponding to the first read/write head 210a.

The output of the amplifier 304 (e.g., the control signal that controls the first driver 312a) is coupled to the first capacitive element 310a, which is illustrated as a capacitor in the example of FIG. 3. The other terminal of the capacitor 310a is coupled to ground. When the logic unit 306 selects the second read/write head 210b (or any of the other read/write heads 210c-e as represented by the dashed box 320 in FIG. 3) for the feedback process described herein, the switches of the first switch module 308a are opened, thereby severing communication between the first driver 312a and the amplifier 304. However, the control voltage generated by the amplifier 304 is preserved (e.g., stored) in the first capacitor 310a. Thus, the voltage stored on the first capacitor 310a drives the elements of the first driver 312a (e.g., a variable current source) when the first read/write head 210a is in an unselected state (e.g., according to the programming of the logic unit 306).

The newly selected read/write head then undergoes the feedback process described herein. Specifically, where the newly selected read/write head is the second read/write head 210b, the logic unit 306 closes the switches of the second switch module 308b, thereby coupling the second current sensor 314b and the second voltage sensor 316b to the common multiplier 300. As described above, the multiplier 300 generates the actual power signal P_{SELECTED}_{_{—}}_{HEATER} based on the second current signal I_{HEATER}_{_{—}}_{B} and the second voltage signal V_{HEATER}_{_{—}}_{B}. The amplifier 304 then generates a control voltage based on a comparison between the actual power signal P_{SELECTED}_{_{—}}_{HEATER} and the power signal P_{DESIRED} received from the DAC 302. This control voltage is conveyed to the second driver 312b, via the second switch module 308b, to control the amount of current (and therefore heat dissipation) delivered to the second resistive element 318b. As described above in connection with the first read/write head 210a, the second capacitor 310b stores the control voltage generated by the amplifier 304 for use during a time in which the second read/write head 210b is not selected for the feedback process.

The first read/write head 210a will be selected again at a later time for the feedback process described herein and, in response, the amplifier 304 will generate a control signal to either maintain the power being delivered to the resistive element 318a or to adjust the same according to any differences between the desired power signal P_{DESIRED} and the actual power signal P_{SELETED}_{_{—}}_{HEATER}.

The selection of one of the plurality of read/write heads 210a-e for the feedback process continues while, for example, the device in which the example HDD 200 is active or powered on. In the illustrated example of FIG. 3, one of the read/write heads 210a-e is selected for the feedback process in a cyclical sequence. In the example of FIG. 3, the logic unit 306 is programmed to select one of the read/write heads 210a-e in the following sequence: the first read/write head 210a, the second read/write head 210b, the third read/write head 210c, the fourth read/write head 210d, the fifth read/write head 210e, the first read/write head 210a, the second read write head 210b, etc. In some examples, the sequence may vary according to the status of each of the read/write heads 210a-e. For example, the HDD 200 may not need to access one or more of the read/write heads 210a-e for a certain time period (e.g., during a task or execution of a program). In such instances, the sequence through which the logic unit 306 progresses may skip the one or more read/write heads that are not required for that time period or task. For example, where the HDD 200 does not need to access the second read/write head 210b, the sequence listed above may change to the following: the first read/write head 210a, the third read/write head 210c, the fourth read/write head 210d, the fifth read/write head 210e, the first read/write head 210a, the third read write head 210c, the fourth read/write head 210d, etc.

FIG. 4 is an example group of plots showing a plurality of signals of the example heater control system 202 of FIG. 3 vertically aligned to show relative timing. Specifically, the top four signals of the group of plots represent enable signals (referred to herein and labeled in FIG. 4 as FEEBACK ENABLE_A, FEEDBACK ENABLE_B, FEEBACK ENABLE_C, and FEEDBACK ENABLE_D), each of which correspond to one of the plurality of read/write reads 210a-d of FIG. 2. As described above, in some instances or situations, one or more of read/write heads may be inactive and, thus, not enabled (e.g., for the feedback process described herein). Accordingly, in the illustrated example of FIG. 4, plots corresponding to the last read/write head 210e are omitted.

The enable signals control which one of the read/write heads 210a-e are selected for the feedback process described herein. In the illustrated example, the enable signals are generated by the logic unit 306 of FIG. 3. For illustrative purposes, the logic unit 306 generates FEEDBACK ENABLE_A and conveys the same to the first switch module 308a of the first read/write head 210a. The other enable signals are generated and conveyed to the switch modules associated with the respective read/write heads in a similar manner.

As described above, the logic unit 306 causes the switches of one of the switch modules (e.g., the example first and second switch modules 308a and 308b of FIG. 3) to close, thereby enabling the feedback process for that read/write head and the resistive element disposed therein. The logic high periods (e.g., pulses) of the enable signals in FIG. 4 represent the period of time at which the switches of the selected switch module (e.g., illustrated as the first switch module 308a in the example of FIG. 3) undergo the feedback process to control the thermal expansion associated with the resistive elements disposed in the read/write heads. For illustrative purposes, the state in which the illustrated example circuit of FIG. 3 corresponds to the time period pulse labeled with reference numeral 400 in FIG. 4. After that pulse, the logic unit 306 proceeds through the cyclical sequence described above.

The bottom four signals of the example of FIG. 4 represent the voltages (referred to herein and labeled in FIG. 4 as HEATER VOLTAGE_A, HEATER VOLTAGE_B, HEATER VOLTAGE_C, and HEATER VOLTAGE_D) across the resistive elements (e.g., the first and second resistors 318a and 318b of FIG. 3) disposed in the read/write heads 210a-e. As shown in FIG. 4, the voltages are initially zero at the start of the plots (e.g., at zero microseconds). As the enable signals described above begin the cyclical sequence, each of the voltages climb to a desired level (as determined by the feedback process described herein) in response to the corresponding enable signal going high. As shown in FIG. 4, due to the cyclical nature of the sequence, the last read/write head 210d experiences a delay during a startup period. The example heater control system described below in connection with FIG. 5 addresses the startup delay.

In response to the logic unit 306 closing the switches of the switch modules during a pulse of an enable signal, the corresponding driver (e.g., the first driver 312a of FIG. 3) is coupled to the amplifier 304 of FIG. 3 and begins to deliver current to the corresponding resistive element (e.g., the resistor 318a of FIG. 3). For illustrative purposes, when the logic unit 306 causes FEEDBACK ENABLE_A to go high at approximately four microseconds, the corresponding voltage signal HEATER VOLTAGE_A begins to rise and level off at approximately three and one half volts. The other voltage signals respond to the respective enable signals in a similar manner. As shown by the values listed in the voltage plots, a substantially similar amount of power (e.g., approximately 118 mW) is delivered to each of the read/write heads 210a-d. The resistance of each resistive element (100 ohm, 80 ohm, 130 ohm, and 70 ohm, for resistors 318a, 318b, 318c, and 318d, respectively) may be measured (e.g., during a testing stage) and, as is known, determines the amount of voltage (or current) to deliver to maintain the desired amount of power to the heaters.

As can be seen in FIG. 4, during periods in which the switches of a switch module are open (e.g., while the corresponding enable signal is low), the voltages across the corresponding resistive elements remain at the desired levels. As described above, the capacitive elements (e.g., the capacitors 310a and 310b) coupled to the signals driving the drivers (e.g., the output of the amplifier 304 of FIG. 3) maintain the voltages across the resistive elements while the read/write heads are not undergoing the feedback process.

While the example heater control system 202 of FIG. 3 and the corresponding example plots of FIG. 4 illustrate an HDD with five read/write heads 210a-e, other example HDDs implementing the methods and apparatus described herein may include more read/write heads. In such implementations, the startup delay between the activation of the first read/write head 210a and the fourth read/write head 210d (the last read/write head to be activated in the example of FIG. 4 due to the omission of read/write head 210e), which is labeled with reference numeral 402 in FIG. 4, may create complications and/or difficulties. In some examples, such as HDDs including a minimal amount of read/write heads, the delay 402 may be small enough to ignore (e.g., the negative consequences are negligible). On the other hand, in an HDD that includes more read/write heads, such as ten or twelve, the delay may be large enough to lead to non-negligible negative consequences.

FIG. 5 illustrates another example implementation of the example heater control system 202 of FIG. 2 that addresses the startup delay issue described above. Generally, the example heater control system 202 of FIG. 5 uses a reference voltage and a reference current to initiate current delivery to all of the read/write heads 210a-e in a startup period before the cyclical sequence described above begins. In other words, unlike the example implementation described in connection with and illustrated in FIG. 3 (which included the delay labeled with reference numeral 402 in FIG. 4), in the example implementation of FIG. 5, the drivers associated with each read/write head 210a-e are coupled to an amplifier (as shown by the configuration of the switches of the switch modules in FIG. 5) at the time of startup to begin delivering current to the resistive elements of each read/write head 210a-e without the delay (e.g., the startup delay 402 of FIG. 4) discussed above. As discussed in greater detail below, a dummy head having a reference resistive element is used in a reference generator to provide a reference control signal for the initialization during the startup period. To compensate for the different resistances (e.g., known resistances measured during a testing stage) of the read/write heads that receive the same control signal, the example heater control system 202 of FIG. 5 includes a plurality of adjusters, each dedicated to one read/write head. As described below, the adjusters enable the single reference signal to be shared by read/write heads of varying resistances by altering (e.g., dividing) the reference signal according to the individual resistance of the corresponding read/write head.

The example heater control system 202 of FIG. 5 includes a multiplier 500, a DAC 502, the amplifier 504, a logic unit 506, first and second switch modules 508a and 508b, first and second capacitive elements 510a and 510b, first and second drivers 512a and 512b, first and second current sensors 514a and 514b, first and second voltage sensors 516a and 516b, and first and second resistive elements 518a and 518b. In the illustrated example, the first set of components (those labeled with reference numerals ending in ‘a’) corresponds to a first one of the plurality of read/write heads 210a-e, namely the first read/write head 210a. The second set of components (those labeled with reference numerals ending in ‘b’) corresponds to a second one of the plurality of read/write heads 210a-e, namely the second read/write head 210b. While FIG. 5 shows the portions of the heater control system 202 corresponding to the top two read/write heads 210a and 210b, the example heater control system 202 of FIG. 5 includes similar implementations of the components listed above for the remainder of the read/write heads 210c-e, as represented in FIG. 5 by the dashed box 519.

For purposes of brevity, the example multiplier 500, the example DAC 502, the example amplifier 504, the example first and second capacitive elements 510a and 510b, the example first and second drivers 512a and 512b, the example first and second current sensors 514a and 514b, the example first and second voltage sensors 516a and 516b, and the example first and second resistive elements 518a and 518b of FIG. 5 operate in a substantially similar manner as the corresponding components of the example implementation of FIG. 3. However, the example logic unit 506 of FIG. 5 includes additional and/or alternative programming to control the example switch modules 508a and 508b of FIG. 5 than that of the example logic unit 306 of FIG. 3. In particular, the example logic unit 506 of FIG. 5 includes programming regarding the startup process described below.

In addition to the components described above, the example heater control system 202 of FIG. 5 includes a reference generator 520 associated with a dummy head that is configured to generate a reference voltage V_{REFERENCE} and a reference current I_{REFERENCE}. The reference generator 520 includes a reference switch module 522, a reference current sensor 524, a reference voltage sensor 526, a reference driver 528, a reference capacitive element 530, and a reference resistive element 532. The reference generator 520 creates reference values that are used by the read/write heads 210a-e during a startup period. In particular, the reference generator 520 places a dummy read/write head, having the resistive element 532 disposed within, under the feedback process described above to generate the reference voltage V_{REFERENCE} and the reference current I_{REFERENCE}. The resistance of the resistive element 532 is known via, for example, a measurement taken during a testing stage. As shown in FIG. 5, all of the switches of the switch module 522 are closed (as dictated by the programming of the logic unit 506), thereby enabling the functions of the feedback process described herein. Specifically, the current sensor 524 and the voltage sensor 526 are coupled to the multiplier 500, thereby conveying the reference signals V_{REFERENCE} and I_{REFERENCE} to provide a status of the resistive element 532 (e.g., the amount of power being delivered thereto). The multiplier 500 combines the reference signals V_{REFERENCE} and I_{REFERENCE} to obtain the power level P_{SELECTED}_{_{—}}_{HEATER} of the resistive element 532. As described above in connection with FIG. 3, the amplifier 504 receives the actual power level P_{SELECTED}_{_{—}}_{HEATER} and the desired power level P_{DESIRED} and generates a control signal (referred to in connection with FIG. 5 as a reference control signal) that adjusts the power being delivered to the resistive element 532 to resolve any differences between the actual power level P_{SELECTED}_{_{—}}_{HEATER} and the desired power level P_{DESIRED}.

In the illustrated example of FIG. 5, the reference control signal is also conveyed to the drivers (e.g., the first and second drivers 512a and 512b) of the read/write heads 210a-e during the startup period. As shown in FIG. 5, the switches of the first and second switch modules 508a and 508b dedicated to selectively coupling the amplifier 504 to the first and second drivers 512a and 512b (the bottom switch of both the first switch module 508a and the second switch module 508b) are closed during the startup period, thereby conveying the reference control signal to the first and second drivers 512a and 512b. Of course, the reference control signal is also conveyed to the drivers of the other read/write heads 210c-e, representing by the dashed box 519 in FIG. 5. Thus, the reference control signal causes the first and second drivers 512a and 512b to deliver current to the resistive elements 518a and 518b during the startup period, thereby eliminating the delay (e.g., the delay 402 of FIG. 4) resulting from the cyclical sequence described above.

However, in some implementations, the resistance of each individual resistive element of the read/write heads 210a-e is different. For example, as shown in the example of FIG. 4, the first read/write head 210a has a resistance of one hundred ohms, while the second read/write head 210b has a resistance of 80 ohms. To compensate for such differences during the startup period, in which each read/write head 210a-e is driven by a one reference signal generated via the reference generator, the example heater control system 202 of FIG. 5 includes a plurality of adjusters. In the illustrated example of FIG. 5, a first adjuster 534a is coupled to the first driver 512a and the first switch module 508a (which selectively couples the first adjuster 534a to the amplifier 504) and a second adjuster 534b is coupled to the second driver 512b and the second switch module 508b (which selectively couples the second adjuster 534b to the amplifier 504). As described above and reflected in FIG. 5, during the startup process, the logic unit 506 causes the switches of the first and second switch modules 508a and 508b that couple the amplifier 504 to the drivers 512a and 512b, respectively, to close. In effect, the reference control signal from the amplifier 504 is conveyed to the first and second adjusters 534a and 534b.

Generally, the adjusters 534a and 534b adjust the reference control signal (before it reaches the drivers 512a and 512b) to conform to the specific parameters (e.g., resistance) of the read/write head to which the individual adjusters are dedicated. The individual adjusters described herein are configured according to the known resistance (e.g., as measured during a testing stage) of the resistive elements disposed within the read/write heads. For example, the first adjuster 512a of FIG. 5 is configured according to the known resistance of the first resistive element 518a of the first read/write head 210a. In the illustrated example of FIG. 5, the first and second adjusters 534a and 534b are implemented by voltage dividers that adjust the voltage of the reference control signal. For example, where one of the resistive elements of the read/write heads 210a-e (e.g., the second resistive element 518b) has a relatively (e.g., compared to the known resistance of the reference resistive element 532) low resistance, the corresponding adjuster (e.g., the second adjuster 534b) may reduce the voltage of the reference control signal before it is conveyed to the corresponding driver (e.g., the second driver 512b). Such an approach avoids too large of a current being delivered to the resistive elements and/or, more generally, the read/write heads 210a-e.

After the startup process is completed, the heater control system 202 of FIG. 5 begins the cyclical sequence described above in connection with FIGS. 3 and 4. In the illustrated example of FIG. 5, the reference generator 520 is dormant during the cyclical sequence because the feedback process and the capacitive elements (e.g., the first and second capacitors 510a and 510b) provide the precise signals to the control the heat dissipation in the resistive elements (e.g., the first and second resistive elements 518a and 518b).

While example manners of implementing the heater control system 202 of FIG. 2 have been illustrated in FIGS. 3 and 5, one or more of the elements, processes and/or devices illustrated in FIGS. 3 and/or 5 may be combined, divided, re-arranged, omitted, eliminated and/or implemented in any other way. Further, the example multiplier 300, the example DAC 302, the example amplifier 304, the example logic unit 306, the example first and second switch modules 308a and 308b, the example first and second capacitive elements 310a and 310b, the example first and second drivers 312a and 312b, the example first and second current sensors 314a and 314b, the example first and second voltage sensors 316a and 316b, and/or the example first and second resistive elements 318a and 318b of FIG. 3; the example multiplier 500, the example DAC 502, the example amplifier 504, the example logic unit 506, the example first and second switch modules 508a and 508b, the example first and second capacitive elements 510a and 510b, the example first and second drivers 512a and 512b, the example first and second current sensors 514a and 514b, the example first and second voltage sensors 516a and 516b, the example first and second resistive elements 518a and 518b, the example first and second adjusters 534a and 534b, the example reference switch module 522, the example reference current sensor 524, the example reference voltage sensor 526, the example reference driver 528, the example reference capacitive element 530, the example reference resistive element 532, and/or, more generally, the example reference generator 520 of FIG. 5, may be implemented by hardware, software, firmware and/or any combination of hardware, software and/or firmware.

Thus, for example, any of the example multiplier 300, the example DAC 302, the example amplifier 304, the example logic unit 306, the example first and second switch modules 308a and 308b, the example first and second capacitive elements 310a and 310b, the example first and second drivers 312a and 312b, the example first and second current sensors 314a and 314b, the example first and second voltage sensors 316a and 316b, and/or the example first and second resistive elements 318a and 318b of FIG. 3; the example multiplier 500, the example DAC 502, the example amplifier 504, the example logic unit 506, the example first and second switch modules 508a and 508b, the example first and second capacitive elements 510a and 510b, the example first and second drivers 512a and 512b, the example first and second current sensors 514a and 514b, the example first and second voltage sensors 516a and 516b, the example first and second resistive elements 518a and 518b, the example first and second adjusters 534a and 534b, the example reference switch module 522, the example reference current sensor 524, the example reference voltage sensor 526, the example reference driver 528, the example reference capacitive element 530, the example reference resistive element 532, and/or, more generally, the example reference generator 520 of FIG. 5, could be implemented by one or more circuit(s), programmable processor(s), application specific integrated circuit(s) (ASIC(s)), programmable logic device(s) (PLD(s)), and/or field programmable logic device(s) (FPLD(s)), etc.

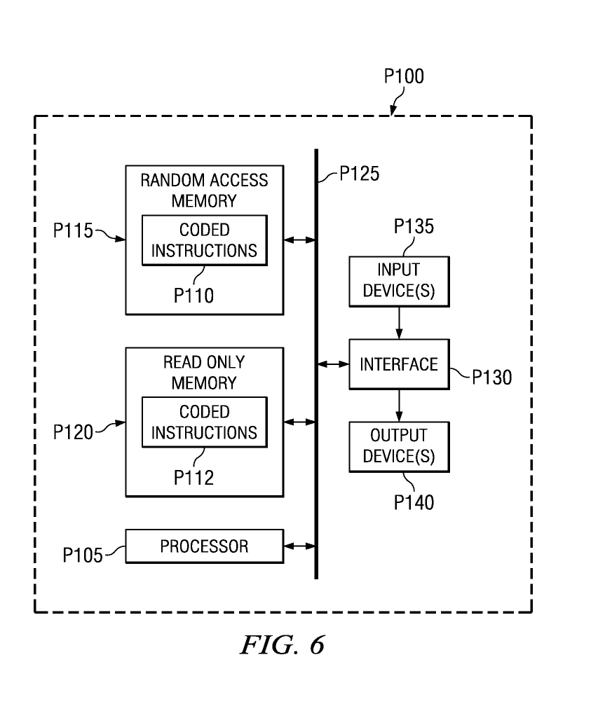

FIG. 6 is a schematic diagram of an example processor platform P100 that may be used and/or programmed to implement an HDD in accordance with the heater control methods and apparatus described herein. The example processor platform P100 can be implemented by one or more general purpose processors, processor cores, microcontrollers, etc.

The processor platform P100 of the example of FIG. 6 includes at least one general purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown).

The processor platform P100 also includes an interface circuit P130. The interface circuit P130 may be implemented by any type of interface standard, such as an external memory interface, serial port, general purpose input/output, etc. One or more input devices P135 and one or more output devices P140 are connected to the interface circuit P130.

Although certain example methods, apparatus and articles of manufacture are described herein, other implementations are possible. The scope of coverage of this patent is not limited to the specific examples described herein. On the contrary, this patent covers all apparatus, methods, and articles of manufacture falling within the scope of the invention.

What is claimed is:

1. A control system for use in a multi-head hard-disk drive, comprising:
a first sensor to provide a first feedback signal indicating a status of a first head;
a second sensor to provide a second feedback signal indicating a status of a second head; and
a shared calculation unit to selectively receive one of the first and second feedback signals for a feedback process to control an expansion of the first and second heads.

2. A control system as defined in claim 1, further comprising capacitive elements coupled to the first and second heads to store a control signal generated by the feedback process.

3. A control system as defined in claim 2, wherein the stored control signal of the capacitive elements controls a power level being delivered to one of the first and second heads while another one of the first and second heads is selected for the feedback process.

4. A control system as defined in claim 1, further comprising a shared amplifier to generate a control signal to be received by a head associated with the selected feedback signal.

5. A control system as defined in claim 1, further comprising a shared converter to convey a desired power signal to a shared amplifier.

6. A control system as defined in claim 1, further comprising a logic unit to control a desired power level based on which of the first and second heads is selected for the feedback process.

7. A control system as defined in claim 1, further comprising a logic unit to determine which of the first and second feedback signals is to be received by the shared calculation unit.

8. A control system as defined in claim 7, further comprising one or more switch modules controlled by the logic unit to selectively couple one of the first and second sensors to the shared calculation unit.

9. A control system as defined in claim 1, wherein the shared calculation unit selectively receives the one of the first and second feedback signal according to a cyclical sequence.

10. A control system for use in a multi-head hard-disk drive, comprising:
first and second heads, both including a resistive element to control a thermal expansion of the first and second heads;
a reference generator associated with a dummy head to generate at least one reference signal to be used by the first and second heads during a startup period; and
a shared calculation unit to selectively receive at least one feedback signal from one of the first head, the second head, or the dummy head to implement a feedback process.

11. A control system as defined in claim 10, wherein the reference signal is to be received by first and second drivers associated with the first and second heads to initiate a delivery of power to the resistive elements.

12. A control system as defined in claim 10, further comprising first and second adjusters corresponding to the first and second heads, wherein the adjusters adjust the reference signal according to resistance of the resistive elements.

13. A control system as defined in claim 12, wherein the adjusters comprise voltage dividers.

14. A control system as defined in claim 10, wherein the dummy head includes a resistive element having a known resistance to generate the reference signal.

15. A control system as defined in claim 10, wherein the first and second heads are cyclically selected for the feedback process after an end of the startup period.

16. A control system as defined in claim 10, further comprising a logic unit to configure a plurality of switch modules coupled to the first and second heads.

17. A control system as defined in claim 16, wherein the logic unit is to cause the switch modules to close a set of switches to communicatively couple the dummy head and the shared calculation unit during the startup period.

18. A control system as defined in claim 10, further comprising capacitive elements coupled to the first and second heads to store a control signal generated by the feedback process.

19. A control system as defined in claim 18, wherein the stored control signal of the capacitive elements controls a power level being delivered to one of the first and second heads while another one of the first and second heads is selected for the feedback process.

20. A control system for use in a multi-head hard-disk drive, comprising:
first and second heads, both including a resistor coupled to a driver to control a power level delivered to the resistor;
a logic unit to select one of the first and second heads for a feedback process;
a shared multiplier to receive one or more feedback signals from the selected head during the feedback process, wherein the shared multiplier is to generate an actual power signal indicative of a status of the selected head;
a shared amplifier, coupled to the shared multiplier, to generate a control signal to be received by the driver of the selected head, wherein the control signal is based on a comparison between the actual power signal and a desired power signal conveyed to the shared amplifier via a digital-to-analog converter;
a first capacitor coupled to the driver of the first head; and
a second capacitor coupled to the driver of the second head, wherein the first and second capacitors are to store the control signal generated during the feedback process to provide the control signal to the driver of the unselected one of the first and second heads.
